(19) United States
(12) Patent Application Publication
(10) Pub. No.: US 2025/0232400 A1
(43) Pub. Date: Jul. 17, 2025

(54) COMPOSITE IMAGE GENERATING DEVICE, METHOD, AND NON-TRANSITORY COMPUTER READABLE STORAGE MEDIUM THEREOF

(71) Applicant: HTC Corporation, Taoyuan City (TW)

(72) Inventors: Yung Hung CHEN, Taoyuan City (TW); Yen-Jung LEE, Taoyuan City (TW)

(21) Appl. No.: 18/414,473

(22) Filed: Jan. 17, 2024

(51) Int. Cl. H04N 5/265; G06F 1/16; G06F 3/01; G06T 3/4053; G06T 7/73

(52) U.S. Cl. CPC G06T 3/4053; G06F 1/163; G06F 3/013; G06T 7/73; G06T 2207/10144; G06T 2207/20212

(57) ABSTRACT

A composite image generating device, method, and non-transitory computer readable storage medium thereof are provided. The device determines an eye gaze position of a user. The device determines a region of interest corresponding to a plurality of real-time images based on the eye gaze position, and each of the real-time images corresponds to an exposure value and a resolution. The device generates a composite image based on the region of interest and a region of non-interest corresponding to the real-time images, and the region of interest and the region of non-interest of the composite image are generated based on the real-time images corresponding to different of the resolutions. The device transmits the composite image to a display device for a real-time display operation.

### BACKGROUND

### Field of Invention

The present invention relates to a composite image generating device, method, and non-transitory computer readable storage medium thereof. More particularly, the present invention relates to a composite image generating device, method, and non-transitory computer readable storage medium thereof that improves the efficiency of generating composite images.

### Description of Related Art

In recent years, various technologies related to virtual reality have developed rapidly, and various technologies and applications have been proposed one after another.

In the prior art, when performing interactive operations, the head-mounted device may capture real-time images of the physical space through cameras installed in the environment or on the device and display them on the display screen (e.g., by an optical see-through operation or a video see-through operation).

However, since there may be both extremely bright and extremely dark areas in the real-time image (e.g., windows with strong sunlight and corners of rooms), the content in the image cannot be clearly presented (e.g., the image is overexposed or underexposed), resulting in poor user experience.

In addition, even the existing technology can generate images with a wider brightness range by synthesizing multiple real-time images with different exposure ranges. However, since processing real-time images containing a large amount of image details requires a large amount of calculation and time costs, the number of frames per second (FPS) for displaying images is reduced. Since in a head-mounted device, too low FPS may cause users to feel dizzy, the existing synthesizing method cannot be used for real-time display device.

Accordingly, there is an urgent need for a composite image generating technology that can improve the efficiency of generating composite images.

### SUMMARY

An objective of the present disclosure is to provide a composite image generating device. The composite image generating device comprises a transceiver interface and a processor, and the processor is electrically connected to the transceiver interface. The processor determines an eye gaze position of a user. The processor determines a region of interest corresponding to a plurality of real-time images based on the eye gaze position, wherein each of the real-time images corresponds to an exposure value and a resolution. The processor generates a composite image based on the region of interest and a region of non-interest corresponding to the real-time images, wherein the region of interest and the region of non-interest of the composite image are generated based on the real-time images corresponding to different of the resolutions. The processor transmits the composite image to a display device for a real-time display operation.

Another objective of the present disclosure is to provide a composite image generating method, which is adapted for use in an electronic apparatus. The composite image generating method comprises the following steps: determining an eye gaze position of a user; determining a region of interest corresponding to a plurality of real-time images based on the eye gaze position, wherein each of the real-time images corresponds to an exposure value and a resolution; generating a composite image based on the region of interest and a region of non-interest corresponding to the real-time images, wherein the region of interest and the region of non-interest of the composite image are generated based on the real-time images corresponding to different of the resolutions; and transmitting the composite image to a display device for a real-time display operation.

A further objective of the present disclosure is to provide a non-transitory computer readable storage medium having a computer program stored therein. The computer program comprises a plurality of codes, the computer program executes a composite image generating method after being loaded into an electronic apparatus. The composite image generating method comprises the following steps: determining an eye gaze position of a user; determining a region of interest corresponding to a plurality of real-time images based on the eye gaze position, wherein each of the real-time images corresponds to an exposure value and a resolution; generating a composite image based on the region of interest and a region of non-interest corresponding to the real-time images, wherein the region of interest and the region of non-interest of the composite image are generated based on the real-time images corresponding to different of the resolutions; and transmitting the composite image to a display device for a real-time display operation.

According to the above descriptions, the composite image generating technology (at least including the device, the method, and the non-transitory computer readable storage medium) provided by the present disclosure performs corresponding metering operations by analyzing the user's eye gaze position, and determines the components of the composite image based on the brightness value of the eye gaze position. The composite image generating technology provided by the present disclosure provides that the important parts of the composite image are composed of higher-resolution real-time images, and the less important parts of the composite image are composed of lower-resolution real-time images, thereby improving the efficiency of generating composite images. Since the composite image generating technology provided by the present disclosure solves the problem that the existing technology cannot be applied to real-time display, it improves the user's service experience.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting a composite image generating device of the first embodiment;

FIG. 2 is a schematic view depicting a metering image of some embodiment;

FIG. 3 is a schematic view depicting real-time images of some embodiments;

FIG. 4 is a schematic view depicting real-time images of some embodiments; and

FIG. 5 is a partial flowchart depicting a composite image generating method of the second embodiment.

### DETAILED DESCRIPTION

In the following description, a composite image generating device, method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

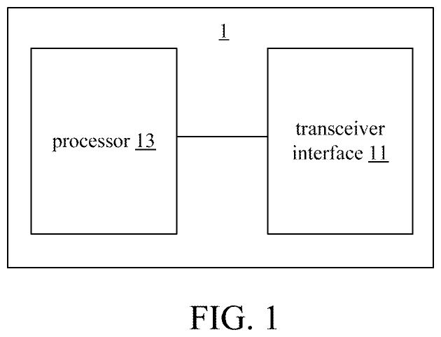

A first embodiment of the present disclosure is a composite image generating device 1 and a schematic view of which is depicted in FIG. 1. In the present embodiment, the composite image generating device 1 comprises a transceiver interface 11 and a processor 13, wherein the processor 13 is electrically connected to the transceiver interface 11.

It shall be appreciated that the processor 13 may be any of various processors, Central Processing Units (CPUs), microprocessors, digital signal processors or other coordinate system offset calculating apparatuses known to those of ordinary skill in the art. The transceiver interface 11 is an interface capable of receiving and transmitting data or other interfaces capable of receiving and transmitting data and known to those of ordinary skill in the art.

In some embodiments, the composite image generating device 1 can be communicatively connected to a display device (e.g., a head mounted display (HMD)) to transmit the generated composite image to the display device for real-time display.

In some embodiments, the composite image generating device 1 can be disposed in other devices or combined with a device having computing capabilities (e.g., sharing the processor with the device). For example, the composite image generating device 1 can be disposed in a head-mounted display, the processor 13 can be a processor built into the head-mounted display, and the transceiver interface 11 can be a transceiver interface built into the head-mounted display. The composite image generating device 1 can transmit the generated composite image to the display device in the head-mounted display for real-time display.

First, in the present embodiment, the processor 13 in the composite image generating device 1 determines the corresponding eye gaze position of the user (e.g., the user using a head-mounted display). Specifically, the processor 13 may determine the eye gaze position of the user based on an eye tracking information of the user in a metering image.

In some embodiments, the eye tracking information can be generated by analyzing the position of the user's eyes on the screen (e.g., the eye tracking technology).

In some embodiments, the processor 13 can measure the light of the environment in advance (e.g., through a pre-generated metering image or one of multiple real-time images as the metering image) and determine the position where the user's eyes are looking.

It shall be appreciated that in some embodiments, the processor 13 may first measure the light at the eye gaze position, and then generate a plurality of corresponding real-time images based on the light metering results.

Next, in the present embodiment, the processor 13 determines a region of interest corresponding to a plurality of real-time images based on the eye gaze position, and each of the real-time images corresponds to an exposure value and a resolution.

In some embodiments, the processor 13 may use the target pixel position with a similar brightness value as the region of interest. Specifically, the processor 13 calculates a brightness value of the metering image at the eye gaze position. Then, the processor 13 generates a plurality of target pixel positions corresponding to the brightness value in the metering image. Finally, the processor 13 determines the region of interest based on the target pixel positions.

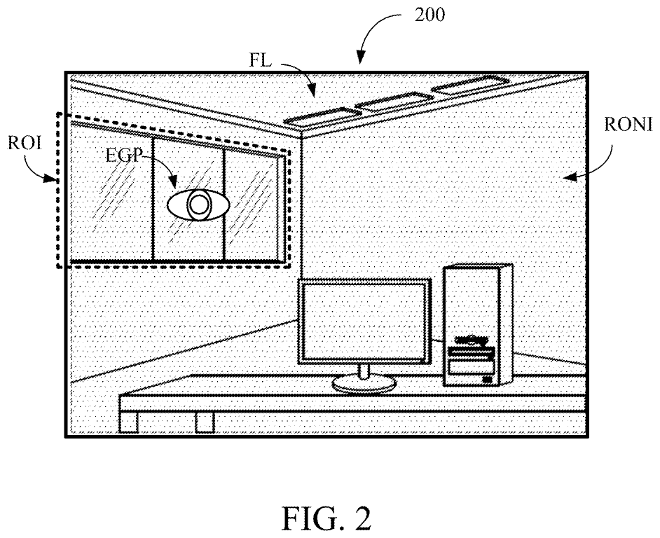

For ease of understanding, please refer to the real-time image diagram 200 in FIG. 2. As shown in FIG. 2, the processor 13 determines that the eye gaze position EGP corresponding to the user is located at the window. In the present example, since the window parts all have similar brightness values (i.e., fall within a threshold range), the processor 13 uses the window areas with similar brightness values as the region of interest ROI.

In some examples, when the measured brightness value of the area of the fluorescent lamp FL may be similar to the window area, the processor 13 can also add the area of the fluorescent lamp FL to the region of interest ROI, so the region of interest ROI can be simultaneously containing the windows area and the fluorescent lamp FL area.

In some embodiments, the processor 13 can determine the object focused on by the eye gaze position as the region of interest based on the operation of identifying the object. Specifically, the processor 13 identifies a target object corresponding to the eye gaze position in the metering image. Then, the processor 13 generates a plurality of target pixel positions corresponding to the target object in the metering image. Finally, the processor 13 determines the region of interest based on the target pixel positions.

For example, as shown in FIG. 2, the processor 13 identifies that the object focused on by the user's eye gaze is a window, and the processor 13 calculates the pixel area where the window appears in the image as the region of interest ROI.

Next, in the present embodiment, the processor 13 generates a composite image based on the region of interest and a region of non-interest corresponding to the real-time images, and the region of interest and the region of non-interest of the composite image are generated based on the real-time images corresponding to different of the resolutions.

In some embodiments, pixel positions that do not belong to the region of interest are regarded as the region of non-interest. Specifically, the processor 13 can generate the region of non-interest corresponding to other remaining areas after determining the region of interest corresponding to the real-time image.

In some embodiments, since the region of interest is the area that the user is more concerned about (i.e., the region of interest where the user's eyes are looking), the processor 13 may integrate the region of interest of the composite image with a real-time image with a higher resolution, and integrate the region of non-interest of the composite image with a real-time image with a lower resolution, thereby reducing the cost of computing resources. Specifically, the processor 13 generates a plurality of first region pixel values corresponding to the region of interest based on the real-time images corresponding to a first resolution. Then, the processor 13 generates a plurality of second region pixel values corresponding to the region of non-interest based on the real-time images corresponding to a second resolution. Finally, the processor 13 synthesizes the first region pixel values and the second region pixel values to generate the composite image, wherein the first resolution is higher than the second resolution.

In some embodiments, the processor 13 may extract pixel values corresponding to each pixel position in the region of interest from the real-time images corresponding to the first resolution as the first region pixel values (i.e., the pixel values for all pixel positions located within the region of interest). In addition, the processor 13 may extract pixel values corresponding to each pixel position in the region of non-interest from the real-time images corresponding to the second resolution as the second region pixel values (i.e., the pixel values for all pixel positions located within the region of non-interest).

In some embodiments, the processor 13 can determine the exposure value and the resolution corresponding to each of the real-time images through the brightness value of the eye gaze position. By increasing the resolution of real-time images with similar brightness values and reducing the resolution of other real-time images, the calculation cost is reduced.

Specifically, the processor 13 calculates a brightness value of the metering image at the eye gaze position. Then, the processor 13 determines the exposure value and the resolution corresponding to each of the real-time images based on the brightness value of the metering image at the eye gaze position, wherein the real-time images are generated by at least one image capturing device based on the exposure value and the resolution corresponding to each of the real-time images. It shall be appreciated that the real-time images are generated by at least one image capturing device based on the exposure value and the resolution corresponding to each of the real-time images.

In some embodiments, among the real-time images, the real-time image that is close to the brightness value of the eye gaze position corresponds to the highest resolution.

In some embodiments, the processor 13 can also actively reduce the resolution corresponding to some real-time images (i.e., real-time images corresponding to components of the region of non-interest) to reduce the cost of calculation.

It shall be appreciated that the resolution reduction disclosed in the present disclosure can be used to perform the image capturing operation with lower parameter settings when the image capturing device is shooting, or to actively reduce the resolution corresponding to the real-time image in a post-production manner.

In some embodiments, the processor 13 may actively perform a resolution reduction operation on real-time images that are not related to the composition of the region of interest to reduce computing resource costs. Specifically, the processor 13 calculates a brightness value of a metering image at the eye gaze position. Then, the processor 13 selects at least one second real-time image from the real-time images based on the brightness value of the metering image at the eye gaze position and the brightness value of the real-time images corresponding to the region of interest. Finally, the processor 13 performs a resolution reduction operation on the at least one second real-time image to generate the real-time images corresponding to the second resolution.

Finally, in the present embodiment, the processor 13 transmits the composite image to a display device for a real-time display operation.

In some embodiments, the display device is a head-mounted display, and the head-mounted display is worn by the user.

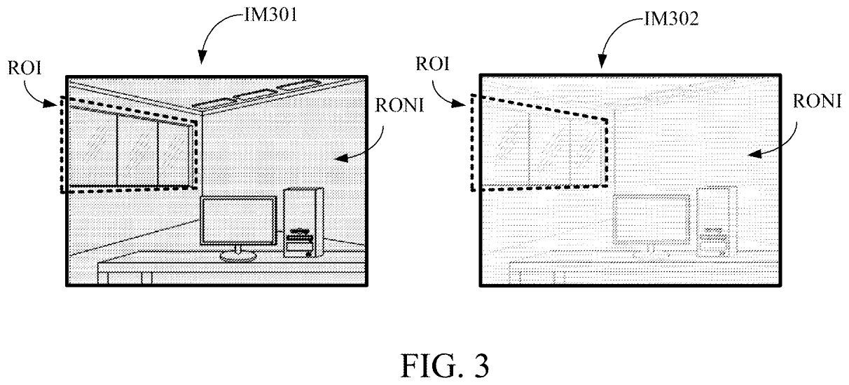

For ease of understanding, take the processor 13 to generate a composite image based on two real-time images as an example. Please refer to the schematic diagram of the real-time image IM301 and the real-time image IM302 in FIG. 3. In the present example, the real-time image IM301 has a lower exposure value (i.e., underexposed) and a higher resolution, and the real-time image IM302 has a higher exposure value (i.e., overexposed) and a lower resolution.

It shall be appreciated that since the exposure value of the real-time image IM301 is low, the details of the window area with higher brightness are relatively clear. In addition, since the exposure value of the real-time image IM302 is higher, the pixel details in the window area with higher brightness will contain less pixel details due to overexposure.

In the present example, since the region of interest ROI corresponds to the window area with higher brightness, the processor 13 captures the plurality of region pixel values of the region of interest ROI of the real-time image IM301 (i.e., the bright details are clearer) as part of the composite image (i.e., the region of interest ROI of the composite image). In addition, the processor 13 captures the plurality of region pixel values of the region of non-interest RONI of the real-time image IM302 (i.e., the bright details are blurred) as another part of the composite image (i.e., the region of non-interest RONI of the composite image).

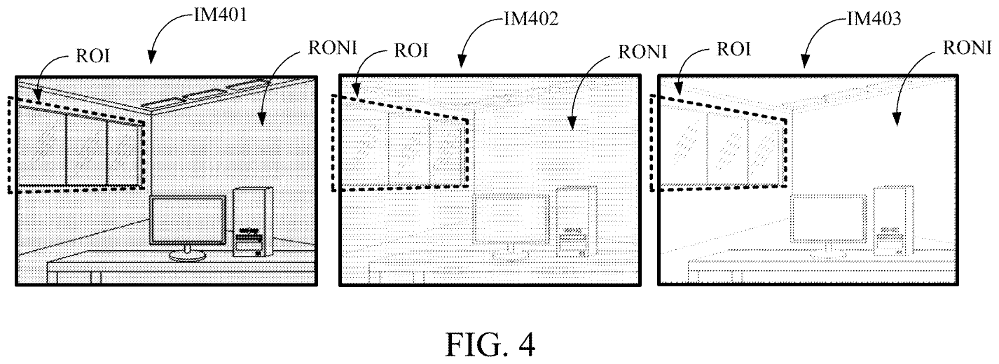

In addition, taking the processor 13 to generate a composite image based on three real-time images as an example, please refer to the schematic diagram of the real-time image IM401, the real-time image IM402, and the real-time image IM403 in FIG. 4. In the present example, the real-time image IM401 has a lower exposure value (i.e., underexposed) and a higher resolution, the real-time image IM402 has a normal exposure value and a lower resolution, and the real-time image IM403 has a higher exposure value (i.e., overexposed) and a lower resolution.

It shall be appreciated that since the exposure value of the real-time image IM401 is low, the details of the window area with higher brightness are relatively clear. In addition, since the exposure value of the real-time images IM402 and IM403 is higher, the pixel details in the window area with higher brightness will contain less pixel details due to overexposure.

In the present example, since the region of interest ROI corresponds to the window area with higher brightness, the processor 13 captures the plurality of region pixel values of the region of interest ROI of the real-time image IM401 (i.e., the bright details are clearer) as part of the composite image (i.e., the region of interest ROI of the composite image). In addition, the processor 13 captures the plurality of region pixel values of the region of non-interest RONI of the real-time image IM402 and the real-time image IM403 (i.e., the bright details are blurred) as another part of the composite image (i.e., the region of non-interest RONI of the composite image).

It shall be appreciated that the real-time images required for the composite image of the present disclosure are at least two real-time images. The present disclosure does not limit the number of real-time images used for composite images. Those with ordinary knowledge in the art should be able to understand other implementations of more real-time images based on the descriptions of the present disclosure, so no further details are given here. In addition, when the processor 13 synthesizes the region of non-interest RONI through multiple real-time images, the region of non-interest RONI can be synthesized through weight ratio and other methods.

It shall be appreciated that in the present disclosure, the real-time images may be generated by a single image capturing device or by a plurality of image capturing devices (for example, cameras with better and worse resolutions).

In some embodiments, a single image capturing device can continuously capture real-time images of different resolutions by setting different exposure times (for example: the single image capturing device corresponds to a plurality of exposure parameters and a plurality of resolution parameters). Specifically, the single image capturing device generates the real-time images based on the first exposure parameters and the first resolution parameters.

In some embodiments, the real-time images can be captured by a plurality of image capturing devices by setting different exposure parameters and resolution parameters. Specifically, the image capturing devices generate the real-time images based on the second exposure parameters and the second resolution parameters.

According to the above descriptions, the composite image generating device 1 provided by the present disclosure performs corresponding metering operations by analyzing the user's eye gaze position, and determines the components of the composite image based on the brightness value of the eye gaze position. The composite image generating device 1 provided by the present disclosure provides that the important parts of the composite image are composed of higher-resolution real-time images, and the less important parts of the composite image are composed of lower-resolution real-time images, thereby improving the efficiency of generating composite images. Since the composite image generating device 1 provided by the present disclosure solves the problem that the existing technology cannot be applied to real-time display, it improves the user's service experience.

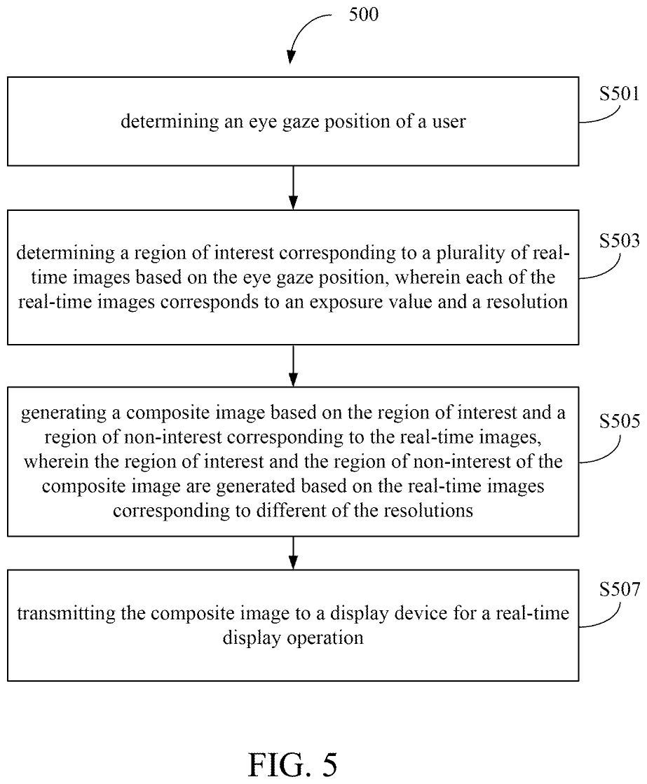

A second embodiment of the present disclosure is a composite image generating method and a flowchart thereof is depicted in FIG. 5. The composite image generating method 500 is adapted for an electronic apparatus (e.g., the composite image generating device 1 of the first embodiment). The composite image generating method 500 generates a composite image through the steps S501 to S507.

In the step S501, the electronic apparatus determines an eye gaze position of a user.

Next, in the step S503, the electronic apparatus determines a region of interest corresponding to a plurality of real-time images based on the eye gaze position, wherein each of the real-time images corresponds to an exposure value and a resolution.

Next, in the step S505, the electronic apparatus generates a composite image based on the region of interest and a region of non-interest corresponding to the real-time images, wherein the region of interest and the region of non-interest of the composite image are generated based on the real-time images corresponding to different of the resolutions.

Finally, in the step S507, the electronic apparatus transmits the composite image to a display device for a real-time display operation.

In some embodiments, wherein the step of generating the composite image further comprises the following steps: generating a plurality of first region pixel values corresponding to the region of interest based on the real-time images corresponding to a first resolution; generating a plurality of second region pixel values corresponding to the region of non-interest based on the real-time images corresponding to a second resolution; and synthesizing the first region pixel values and the second region pixel values to generate the composite image, wherein the first resolution is higher than the second resolution.

In some embodiments, wherein the real-time images corresponding to the second resolution are generated by the following steps: calculating a brightness value of a metering image at the eye gaze position; selecting at least one second real-time image from the real-time images based on the brightness value of the metering image at the eye gaze position and the brightness value of the real-time images corresponding to the region of interest; and performing a resolution reduction operation on the at least one second real-time image to generate the real-time images corresponding to the second resolution.

In some embodiments, wherein the step of determining the eye gaze position of the user further comprises the following steps: determining the eye gaze position of the user based on an eye tracking information of the user in a metering image.

In some embodiments, wherein the real-time images are generated by the following steps: calculating a brightness value of the metering image at the eye gaze position; and determining the exposure value and the resolution corresponding to each of the real-time images based on the brightness value of the metering image at the eye gaze position, wherein the real-time images are generated by at least one image capturing device based on the exposure value and the resolution corresponding to each of the real-time images.

In some embodiments, wherein the step of determining the region of interest further comprises the following steps: calculating a brightness value of the metering image at the eye gaze position; generating a plurality of target pixel positions corresponding to the brightness value in the metering image; and determining the region of interest based on the target pixel positions.

In some embodiments, wherein the step of determining the region of interest further comprises the following steps: identifying a target object corresponding to the eye gaze position in the metering image; generating a plurality of target pixel positions corresponding to the target object in the metering image; and determining the region of interest based on the target pixel positions.

In some embodiments, wherein the real-time images are generated by a single image capturing device, the single image capturing device corresponds to a plurality of first exposure parameters and a plurality of first resolution parameters, and the real-time images are generated by the following steps: generating, by the single image capturing device, the real-time images based on the first exposure parameters and the first resolution parameters.

In some embodiments, wherein the real-time images are generated by a plurality of image capturing devices, each of the image capturing devices corresponds to a second exposure parameter and a second resolution parameter, and the real-time images are generated by the following steps: generating, by the image capturing devices, the real-time images based on the second exposure parameters and the second resolution parameters.

In addition to the aforesaid steps, the second embodiment can also execute all the operations and steps of the composite image generating device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The composite image generating method described in the second embodiment may be implemented by a computer program having a plurality of codes. The computer program may be a file that can be transmitted over the network, or may be stored into a non-transitory computer readable storage medium. After the codes of the computer program are loaded into an electronic apparatus (e.g., the composite image generating device 1), the computer program executes the composite image generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., resolution, region pixel value, exposure parameter, resolution parameter, etc.) are preceded by terms such as “first”, or “second”, and these terms of “first”, or “second” are only used to distinguish these different words. For example, the “first” resolution and the “second” resolution are only used to indicate the resolution used in different operations.

According to the above descriptions, the composite image generating technology (at least including the device, the method, and the non-transitory computer readable storage medium) provided by the present disclosure performs corresponding metering operations by analyzing the user's eye gaze position, and determines the components of the composite image based on the brightness value of the eye gaze position. The composite image generating technology provided by the present disclosure provides that the important parts of the composite image are composed of higher-resolution real-time images, and the less important parts of the composite image are composed of lower-resolution real-time images, thereby improving the efficiency of generating composite images. Since the composite image generating technology provided by the present disclosure solves the problem that the existing technology cannot be applied to real-time display, it improves the user's service experience.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A composite image generating device, comprising:
a transceiver interface; and
a processor, being electrically connected to the transceiver interface, and being configured to perform operations comprising:
determining an eye gaze position of a user;
determining a region of interest corresponding to a plurality of real-time images based on the eye gaze position, wherein each of the real-time images corresponds to an exposure value and a resolution;
generating a composite image based on the region of interest and a region of non-interest corresponding to the real-time images, wherein the region of interest and the region of non-interest of the composite image are generated based on the real-time images corresponding to different of the resolutions; and
transmitting the composite image to a display device for a real-time display operation.

2. The composite image generating device of claim 1, wherein the operation of generating the composite image further comprises the following operations:
generating a plurality of first region pixel values corresponding to the region of interest based on the real-time images corresponding to a first resolution;
generating a plurality of second region pixel values corresponding to the region of non-interest based on the real-time images corresponding to a second resolution; and
synthesizing the first region pixel values and the second region pixel values to generate the composite image, wherein the first resolution is higher than the second resolution.

3. The composite image generating device of claim 2, wherein the real-time images corresponding to the second resolution are generated by the following operations:
calculating a brightness value of a metering image at the eye gaze position;
selecting at least one second real-time image from the real-time images based on the brightness value of the metering image at the eye gaze position and the brightness value of the real-time images corresponding to the region of interest; and
performing a resolution reduction operation on the at least one second real-time image to generate the real-time images corresponding to the second resolution.

4. The composite image generating device of claim 1, wherein the operation of determining the eye gaze position of the user further comprises the following operations:
determining the eye gaze position of the user based on an eye tracking information of the user in a metering image.

5. The composite image generating device of claim 4, wherein the real-time images are generated by the following operations:
calculating a brightness value of the metering image at the eye gaze position; and
determining the exposure value and the resolution corresponding to each of the real-time images based on the brightness value of the metering image at the eye gaze position, wherein the real-time images are generated by at least one image capturing device based on the exposure value and the resolution corresponding to each of the real-time images.

6. The composite image generating device of claim 4, wherein the operation of determining the region of interest further comprises the following operations:
calculating a brightness value of the metering image at the eye gaze position;
generating a plurality of target pixel positions corresponding to the brightness value in the metering image; and
determining the region of interest based on the target pixel positions.

7. The composite image generating device of claim 4, wherein the operation of determining the region of interest further comprises the following operations:
identifying a target object corresponding to the eye gaze position in the metering image;
generating a plurality of target pixel positions corresponding to the target object in the metering image; and
determining the region of interest based on the target pixel positions.

8. The composite image generating device of claim 1, wherein the real-time images are generated by a single image capturing device, the single image capturing device corresponds to a plurality of first exposure parameters and a plurality of first resolution parameters, and the real-time images are generated by the following operations:
generating, by the single image capturing device, the real-time images based on the first exposure parameters and the first resolution parameters.

9. The composite image generating device of claim 1, wherein the real-time images are generated by a plurality of image capturing devices, each of the image capturing devices corresponds to a second exposure parameter and a second resolution parameter, and the real-time images are generated by the following operations:
generating, by the image capturing devices, the real-time images based on the second exposure parameters and the second resolution parameters.

10. The composite image generating device of claim 1, wherein the display device is a head-mounted display, and the head-mounted display is worn by the user.

11. A composite image generating method, being adapted for use in an electronic apparatus, and the composite image generating method comprises:
determining an eye gaze position of a user;
determining a region of interest corresponding to a plurality of real-time images based on the eye gaze position, wherein each of the real-time images corresponds to an exposure value and a resolution;
generating a composite image based on the region of interest and a region of non-interest corresponding to the real-time images, wherein the region of interest and the region of non-interest of the composite image are generated based on the real-time images corresponding to different of the resolutions; and
transmitting the composite image to a display device for a real-time display operation.

12. The composite image generating method of claim 11, wherein the step of generating the composite image further comprises the following steps:
generating a plurality of first region pixel values corresponding to the region of interest based on the real-time images corresponding to a first resolution;
generating a plurality of second region pixel values corresponding to the region of non-interest based on the real-time images corresponding to a second resolution; and
synthesizing the first region pixel values and the second region pixel values to generate the composite image, wherein the first resolution is higher than the second resolution.

13. The composite image generating method of claim 12, wherein the real-time images corresponding to the second resolution are generated by the following steps:
calculating a brightness value of a metering image at the eye gaze position;
selecting at least one second real-time image from the real-time images based on the brightness value of the metering image at the eye gaze position and the brightness value of the real-time images corresponding to the region of interest; and
performing a resolution reduction operation on the at least one second real-time image to generate the real-time images corresponding to the second resolution.

14. The composite image generating method of claim 11, wherein the step of determining the eye gaze position of the user further comprises the following steps:
determining the eye gaze position of the user based on an eye tracking information of the user in a metering image.

15. The composite image generating method of claim 14, wherein the real-time images are generated by the following steps:
calculating a brightness value of the metering image at the eye gaze position; and
determining the exposure value and the resolution corresponding to each of the real-time images based on the brightness value of the metering image at the eye gaze position, wherein the real-time images are generated by at least one image capturing device based on the exposure value and the resolution corresponding to each of the real-time images.

16. The composite image generating method of claim 14, wherein the step of determining the region of interest further comprises the following steps:
calculating a brightness value of the metering image at the eye gaze position;
generating a plurality of target pixel positions corresponding to the brightness value in the metering image; and
determining the region of interest based on the target pixel positions.

17. The composite image generating method of claim 14, wherein the step of determining the region of interest further comprises the following steps:
identifying a target object corresponding to the eye gaze position in the metering image;
generating a plurality of target pixel positions corresponding to the target object in the metering image; and
determining the region of interest based on the target pixel positions.

18. The composite image generating method of claim 11, wherein the real-time images are generated by a single image capturing device, the single image capturing device corresponds to a plurality of first exposure parameters and a plurality of first resolution parameters, and the real-time images are generated by the following steps:
generating, by the single image capturing device, the real-time images based on the first exposure parameters and the first resolution parameters.

19. The composite image generating method of claim 11, wherein the real-time images are generated by a plurality of image capturing devices, each of the image capturing devices corresponds to a second exposure parameter and a second resolution parameter, and the real-time images are generated by the following steps:
generating, by the image capturing devices, the real-time images based on the second exposure parameters and the second resolution parameters.

20. A non-transitory computer readable storage medium, having a computer program stored therein, wherein the computer program comprises a plurality of codes, the computer program executes a composite image generating method after being loaded into an electronic apparatus, the composite image generating method comprises:
determining an eye gaze position of a user;
determining a region of interest corresponding to a plurality of real-time images based on the eye gaze position, wherein each of the real-time images corresponds to an exposure value and a resolution;
generating a composite image based on the region of interest and a region of non-interest corresponding to the real-time images, wherein the region of interest and the region of non-interest of the composite image are generated based on the real-time images corresponding to different of the resolutions; and
transmitting the composite image to a display device for a real-time display operation.
